(19) United States
(12) Patent Application Publication
(10) Pub. No.: US 2009/0214822 A1
(43) Pub. Date: Aug. 27, 2009

(54) MULTILAYERED LAMINATED FABRIC WITH SINGLE SEAM

(75) Inventors: Robert CROOK, Wilson, NC (US); William Daniel Aldrich, Wilson, NC (US)

Correspondence Address: GREENBLUM & BERNSTEIN, P.L.C., 1950 ROLAND CLARKE PLACE, RESTON, VA, 20191, US

(73) Assignee: VOITH PATENT GmbH, Heidenheim (DE)

(21) Appl. No.: 12/036,715

(22) Filed: Feb. 25, 2008

(51) Int. Cl. B32B 3/10; F16G 1/00

(52) U.S. Cl. 428/137; 156/137

(57) ABSTRACT

A system and method of for creating a multilayered laminated fabric having a single seam. The system includes a top base layer having a seam and a roll side base layer having a first end and a second end arranged in a non-contacting manner to form a gap. The method includes joining a top base layer and a roll side base layer together and seaming the top base layer, wherein a gap is formed in the roll side base layer.

### BACKGROUND OF THE INVENTION

1. Field of the Invention

The invention generally relates to multilayered laminated fabric and, in particular, to on-machine seamed multilayered laminated fabric for a papermaking machine.

2. Discussion of Background Information

Multilayered fabrics, such as double layer felts have been used in the papermaking industry to make the dewatering and/or drying process more efficient. Double layer felts can include a single or a double seam. While successful results have been obtained from double layer felts having a single seam, this design poses problems when trying to increase caliper under load and void volume. Problems occur, for example, because the yarns in an added base or mesh have to be cut over the seam, allowing yarns in the base to either work their way out of the base or pull back over the base. As a result, the risk of the paper obtaining a seam mark from the felt increases.

To address the above noted drawbacks, a laminate design having two seams, i.e., one seam on a top base layer and one seam on a bottom base layer, has been created. These designs include superimposing the top base layer and the bottom base layer such that the seam area of the bases are together. The bases are then sewn together in the seam area to secure and stabilize the bases. Once sewn together, pintles can then be inserted to form a bottom base seam and a top base seam. The bases can then be laminated by punching a needle with batt fiber through the bases.

While a laminate seam design having two seams is effective, problems arise when joining the seams. Typically, the bottom base layer is seamed first and then unzipped so a pintle can be inserted into the top base seam. The top base layer is relatively easy to seam, however, the bottom base layer has been shown to be more difficult to seam. This is because the bottom base seam area becomes misaligned from the top base seam area, which makes it difficult, and at times impossible, to insert the pintle into the bottom base seam. Also, once a pintle has been inserted into the top base seam, the bottom base seam cannot be seen. Due to the difficulty in aligning the seam areas and inserting the pintle to form the bottom base seam, the use of this design has become a difficult drawn out process. Moreover, as this design includes four layers, there may be too much caliper and void volume for effective drying in some applications.

Accordingly, there exists a need in the art to overcome the deficiencies and limitations described hereinabove.

### SUMMARY OF THE INVENTION

In a first aspect of the invention, a laminated seam design comprises: a top base layer having a seam and a roll side base layer having a first end and a second end arranged in a non-contacting manner to form a gap. The first end of the laminated seam design can include a first terminal loop and the second end can include a second terminal loop. The first terminal loop and the second terminal loop are structured to prevent the first end and the second end from unraveling. The first terminal loop and the second terminal loop can be formed via a weaving process. A gap can be formed between the first end and the second end. A resin or a polymer can be arranged within the gap. The gap can also be thermoformed using a heating tool.

The bottom base layer of the laminated seam design can include a monofilament yarn, a multifilament yarn, or a twisted yarn. The top base layer of the laminated seam design can be comprised of a different fabric than the roll side base layer.

The top base layer and roll side base layer can be mechanically bonded together, for example, by sewing the top base layer and roll side base layer together. Moreover, the top base layer and the roll side base layer may be chemically bonded to the roll side layer via low melt fibers.

Another aspect of the invention includes a laminated design, which comprises a top base layer having a first seam loop and a second seam loop and a roll side base layer having a first terminal end and a second terminal end. The top base layer and the roll side base layer can be attached to each other so the first seam loop is adjacent the first terminal end and the second seam loop is adjacent the second terminal end. A pintle can be inserted through the first seam loop and the second seam loop to form a seam. The top base layer and the roll side base layer are structured to fit a papermaking machine.

The first terminal end of the laminated design can include a first terminal loop and the second terminal end can include a second terminal loop, which can be formed via a weaving process. The laminated design can include a batt layer adjacent to the top base layer.

In yet another aspect of the invention, a method for forming a belt for a papermaking machine can include joining a top base layer and a roll side base layer together and seaming the top base layer, wherein a gap is formed in the roll side base layer. The joining can be performed by sewing the top base layer and the roll side base layer together in a seam area. The sewing can be performed prior to placing the top base layer and the roll side base layer on the machine.

The method for forming a belt for a papermaking machine can also include needling the top base layer and the roll side base layer. The needling can be performed after sewing the top base layer and the roll side base layer together. The needling can be performed on a batt layer. Additionally, the top base layer and the roll side base layer can be finished.

An aspect of the invention includes forming a first terminal loop from a first end of the roll side base layer and a second terminal loop from a second end of the roll side base layer. The first terminal loop and the second terminal loop can be formed using a weaving process. A gap can be formed between the first terminal loop and the second terminal loop, the gap arranged adjacent to the seam. The top base layer and the roll side base layer can be heatset.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a conventional double layer laminate having a double seam according to the prior art;

FIG. 2 shows a double layer laminate having a single seam in accordance with the present invention; and

FIG. 3 shows a double layer laminate having a thermoformed gap in the roll side base layer in accordance with the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

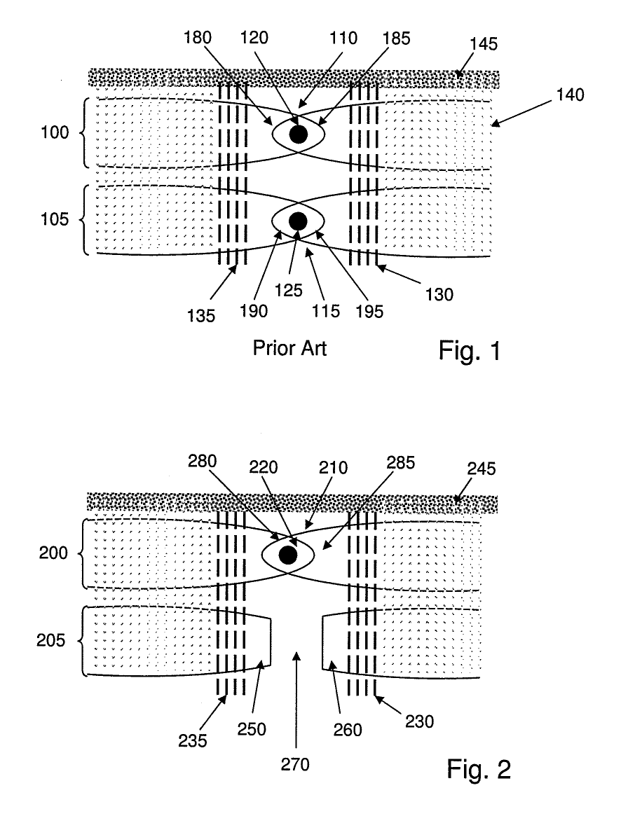

FIG. 1 shows a double layer laminate having a double seam according to the prior art. The double layer laminate has a top base layer 100 and a roll side base layer 105, wherein the roll side base layer 105 is arranged to mirror the top base layer 100. Loops 180 and 185 and 190 and 195 are formed at or on the ends of the top base layer 100 and roll side base layer 105, respectively, and are aligned in a seam area.

Before seaming, the top base layer 100 and the roll side base layer 105 are aligned and sewn in the seam area to secure and stabilize the bases 100, 105. Once the top base layer 100 and roll side base layer 105 are sewn together in the seam area, a top seam 110 and a bottom seam 115 can be formed. Seams 110, 115 are formed, for example, by inserting pintles 120, 125 into the aligned loops 180 and 185 and 190 and 195, respectively, which are formed at the ends of the top base layer 100 and roll side base layer 105. In this manner, the ends of each base layer 100, 105 are connected together and the belt is seamed. Additionally, after pintles 120, 125 is inserted, batt fibers 140 may be needled through the top base 100, and into or through the roll side base 105, and the batt layer 145 (as shown with dashed lines) in order to provide better integrity to the laminate.

FIG. 2 shows a double layer laminate having a single seam in the top base layer 200 in accordance with embodiments of the present invention. This double layer laminate is structured and arranged such that no yarns need to be cut in the seam area or above the top base layer. The double layer laminate includes a top base layer 200 and a roll side base layer 205. The top base layer 200 is formed in a manner generally corresponding to top base layer 100 depicted in FIG. 1, e.g., including functional seam loops. However, unlike the double seam laminate depicted in FIG. 1, roll side base layer 205 does not include a functional loop seam.

Instead of creating a functional loop seam with the roll side base layer 205, the ends of the roll side base layer 205 can be woven to create small terminal seam loops 250, 260, which are designed to withstand unraveling. These small terminal seam loops 250, 260 can be created in embodiments during the weaving process. Further embodiments may employ any number of methods for creating the small terminal seam loops 250, 260 provided that the small terminal seam loops 250, 260 are structured such that, preferentially, the yarns in the fabric comprising the roll side base layer 205 do not unravel.

A stitch or stitches 230, 235 can be sewn into the top base layer 200 and the roll side base layer 205 to join these layers together in the seam area, i.e., adjacent to a seam. When a stitch or stitches 235, 230 sew the top base layer 200 and the roll side base layer 205 together, attention is paid to the size of the roll side base layer 205 relative to the top base layer 200. Beneficially, the roll side base layer 205 is shorter than the top base layer 200, can be made from yarns structured to shrink more than those used in the top base layer 200, or can be shrunk during a heatsetting process. This allows for the top base layer 200 and the roll side base layer 205 to fit onto a papermaking machine without bunching due to the roll side base layer 205.

The process of sewing the top base layer 200 and the roll side base layer 205 together reduces the risk of the roll side base layer 205 delaminating in the seam area. Additionally, this allows the small terminal loops 250, 260 to shrink back into the roll side base and create a gap 270 between the terminal ends of the roll side base layer 205 underneath the top base seam 210 during the needling and finishing operations.

After the top base layer 205 and the roll side base layer 205 are sewn 230, 235 together, a pintle 220 can be inserted into the aligned loops 280, 285 in the top base layer 200 in a cross machine direction to form a seam 210. By joining the loops 280, 285 together to form seam 210, an endless fabric loop is created. Additional embodiments may create a seam 210 by inserting the pintle 220 after the needling and/or finishing operation.

Once seam 210 has been formed, embodiments may further heatset the base layer fabric. Heatsetting may be done, e.g., by stretching the base layer fabric to a desired shape and heating the base layer fabric to maintain the stretched shape. Improved performance from the base layer fabrics may result from the heatsetting process.

A needling operation can be performed after the heatsetting process, or directly after the top base layer 200 and the roll side base layer 205 are sewn together in the seam area and the seam 210 is formed. This operation may be performed mechanically by needling batt fibers through the top base layer 200 and, preferably, into or through the roll side base layer 205 to form a binding. Alternatively, the top base layer 200 and the roll side base layer 205 can be bonded chemically by using, e.g., low melt fibers or providing an acrylic or polyurethane based chemical treatment. In addition to the needling operation, a finishing operation is also contemplated by the present invention. The finishing operation may include, e.g., stretching a felt to a target size, washing the felt, applying a thermal treatment bonding to the felt, etc.

As noted above, a gap 270 can be arranged between the terminal ends of the roll side base layer 205 underneath the top base seam 210. A benefit of aligning the gap 270 with the top base seam 210 is that no blind seam is created, which makes it easier to seam the laminate on a paper machine. Additionally, since the gap 270 is on the roll side base away from the batting sheet 245, there is little to no risk of marks due to the gap 270.

Of course, it is understood that the positioning of the gap 270 relative to the seam 210 may differ between embodiments. For example, embodiments may position the gap 270 symmetrically under the pintle 220, as discussed above, while other embodiments may asymmetrically position or offset the gap 270 relative to the pintle 220. Beneficially, the positioning of the gap 270 may be used to improve caliper and fluid flow.

The size of the gap 270 may vary depending on the embodiment. In some embodiments, the gap width may be between 0.02 and 0.25 inches, and preferably between 0.0625 and 0.125 inches. However, other embodiments may utilize larger or smaller gap widths. Once the base layers 200 and 205 are sewn together in the seam area, the width of gap 270 remains relatively steady.

In embodiments, the gap 270 can be filled with a polymer, resin, etc. Filling the gap 270 provides a number of recognizable advantages such as providing a homogenous caliper in the seam area, enhancing bonding and adhesion in the gap 270, helping to eliminate any risk that a seam mark may occur, as well as extending seam life.

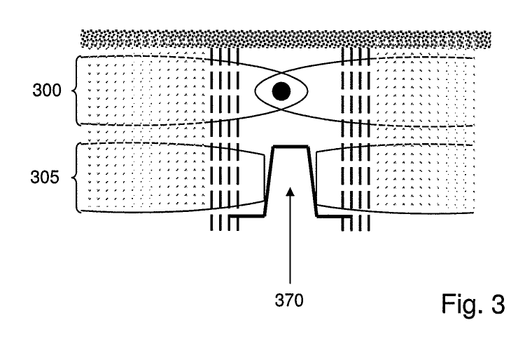

FIG. 3 illustrates a double layer laminate having a top base layer 300 and a roll side base layer 305, wherein the gap 370 in the roll side base layer 305 is thermoformed using heating tools. This thermoforming may be done using a shaped apparatus to heat and melt the fibers surrounding the gap, thereby forming a clean, dense, notch adjacent to the top base layer seam. Embodiments may use thermoforming on a gap 370 that has been at least partially filled with a polymer, resin, etc., or on a gap 370 that has not been filled. Benefits of thermoforming a gap 370 include improved fiber bonding, which causes water flow patterns to change and prevents water flow marks from occurring in the product.

Referring back to FIG. 2, a number of materials can be used to create the top base layer 200 and the roll side base layer 205. Embodiments may use the same materials for both the top base layer 200 and the roll side base layer 205, or alternatively use different materials for each layer. For illustrative purposes, references to roll side base layer materials are discussed below, however, it should be understood that some or all of the materials might also be used to form the top base layer 200.

The roll side base layer 205 may be created from woven double layer, single layer, or 1.5 layer fabrics. In those embodiments using a 1.5 layer fabric, the small terminal seam loops 250, 260 are structured to lay flat, which advantageously provides for even caliper in the nip. Further embodiments may create the roll side base layer 205 from a weave made out of unusually small edge cord. This unusually small edge cord may be, e.g., approximately 50 percent smaller than the edge cord used in the top base layer 200, and can range in size from approximately, e.g., 0.008 inches to 0.06 inches.

Since the rollside base layer 205 is not required to be seamed, the machine direction yarns in the roll side base layer 205 can be formed from solid monofilament, cabled monofilament, plied monofilament, nylon monofilament, twisted multifilament, low melt yarns, etc. Embodiments may use one of these fibers, or any combination of these fibers, to create machine direction yarns that perform well given the requirements of the invention. For example, if the seaming process discussed above proves to be difficult using solid monofilament fibers then multifilament fibers or a combination of monofilament fibers may be used to facilitate the seaming process.

Embodiments of the invention may utilize flat-woven fabrics or endless-woven fabrics. Additionally, embodiments may use a warp binding seam weave to give the fabric better stability and compaction resistance.

The loops of the bottom base layer 205 may be filled with various yarns before the needling process. This allows for increased bonding of the bottom base layer 205 to the top base layer 200. Additionally, this allows for improved uniformity of caliper and fluid flow.

It is noted that the foregoing examples have been provided merely for the purpose of explanation and are in no way to be construed as limiting of the present invention. While the present invention has been described with reference to an exemplary embodiment, it is understood that the words, which have been used herein, are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A laminated seam design comprising:
a top base layer having a seam; and
a roll side base layer having a first end and a second end arranged in a non-contacting manner to form a gap.

2. The laminated seam design of claim 1, wherein the first end includes a first terminal loop and the second end includes a second terminal loop, whereby the first terminal loop and the second terminal loop are structured to prevent the first end and the second end from unraveling.

3. The laminated seam design of claim 2, wherein the first terminal loop and the second terminal loop are formed via a weaving process.

4. The laminated seam design of claim 1, wherein the gap is formed between the first end and the second end.

5. The laminated seam design of claim 4, further comprising a resin or a polymer arranged within the gap.

6. The laminated seam design of claim 4, wherein the gap is thermoformed using a heating tool.

7. The laminated seam design of claim 1, wherein the bottom base layer comprises a monofilament yarn, a multifilament yarn, or a twisted yarn.

8. The laminated seam design of claim 1, wherein the top base layer is comprised of a different fabric than the roll side base layer.

9. The laminated seam design of claim 1, wherein the top base layer and roll side base layer are mechanically bonded together.

10. The laminated seam design of claim 9, wherein the top base layer and the roll side base layer are mechanically bonded by sewing.

11. The laminated seam design of claim 1, wherein the top base layer and the roll side base layer are chemically bonded to the roll side layer via low melt fibers.

12. A laminated design comprising:
a top base layer having a first seam loop and a second seam loop; and
a roll side base layer having a first terminal end and a second terminal end, wherein the top base layer and the roll side base layer are attached to each other so the first seam loop is adjacent the first terminal end and the second seam loop is adjacent the second terminal end.

13. The laminated design of claim 12, further comprising a batt layer adjacent to the top base layer.

14. The laminated design of claim 12, wherein a pintle is inserted through the first seam loop and the second seam loop to form a seam.

15. The laminated design of claim 12, wherein the first terminal end includes a first terminal loop and the second terminal end includes a second terminal loop, which are formed via a weaving process.

16. The laminated design of claim 12, wherein the top base layer and the roll side base layer are structured to fit a papermaking machine.

17. A method for forming a belt for a papermaking machine, comprising:
joining a top base layer and a roll side base layer together; and
seaming the top base layer, wherein a gap is formed in the roll side base layer.

18. The method of claim 17, wherein the joining comprising sewing the top base layer and the roll side base layer together in a seam area.

19. The method of claim 18, wherein the sewing is performed prior to placing the top base layer and the roll side base layer on the machine.

20. The method of claim 17, further comprising needling the top base layer and the roll side base layer.

21. The method of claim 20, wherein the needling is performed after sewing the top base layer and the roll side base layer together.

22. The method of claim 17, further comprising finishing the top base layer and the roll side base layer.

23. The method of claim 17, further comprising forming a first terminal loop from a first end of the roll side base layer and a second terminal loop from a second end of the roll side base layer.

24. The method of claim 23, wherein the first terminal loop and the second terminal loop are formed using a weaving process.

25. The method of claim 23, wherein the gap is formed between the first terminal loop and the second terminal loop, the gap arranged adjacent to the seam.

26. The method of claim 20, further comprising needling a batt layer.

27. The method of claim 17, further comprising heatsetting at least one of the top base layer and the roll side base layer.
